(19) United States
(12) Patent Application Publication
(10) Pub. No.: US 2014/0117599 A1
(43) Pub. Date: May 1, 2014

(54) Mechanical Device for the Seismic Protection of Civil Works

(71) Applicant: FCC CONSTRUCCION, S.A., Madrid (ES)

(72) Inventors: Jose Luis ALVAREZ POYATOS, Madrid (ES); Jose MARTINEZ SALCEDO, Madrid (ES)

(73) Assignee: FCC CONSTRUCCION, S.A., Madrid (ES)

(21) Appl. No.: 13/666,352

(22) Filed: Nov. 1, 2012

(51) Int. Cl. E04B 1/98; F16F 3/00

(52) U.S. Cl. CPC E04B 1/98; F16F 3/00
USPC 267/136

(57) ABSTRACT

The device of the invention consists in a telescopic element with two arms, one of them movable within the other, having in its corresponding ends attachment means (3), so that the shorter arm (2) has means with an axial groove (5) which in the normal working situation is operatively opposite in respect to an axial chamber (6) of the internal portion of the longer arm (1), so that in said chamber a blocking element is movable vertically in respect to the groove, preferably a cylinder (7) opposing the effort of an elastic element located within the corresponding housing (11) which is encased in said groove (5) blocking the device and permitting its unblocking once the effort of the elastic means on the cylinder is exceeded. The device is reusable and it is easily adjustable to different levels of effort for its unblocking.

### OBJECT OF THE INVENTION

The invention refers to a device which has been specially designed for its installation in structures of civil works, in parallel to a number of dampers, in order to mitigate the effects produced by seismic vibrations.

The aim of the invention is to provide a mechanical device to permit the actuation of other devices once exceeded a predetermined effort level, which may be easily adjusted, without wear or maintenance problems, having as well a reusable character.

### BACKGROUND OF THE INVENTION

Within the field of the practical application of the invention that is, civil work structures, various types of dampers are known for seismic engineering, which act as union elements between two structures which must stay without relative movement in the normal work situation but which in front of high efforts produced by seismic effects must permit the displacement between said structures in order to absorb the vibrations with the assistance of a number of dampers parallely arranged to the mechanical protection device or forming part of the same.

In this connection, the mechanical protection devices used up to now may be divided into two groups: hydraulic protection devices and mechanical protection devices.

The hydraulic protection devices comprise telescopic elements within which two variable volume chambers are defined depending on the position of said elements, so that to permit the extension of the telescopic element it is necessary that the oil or silicone contained within one of the chambers moves to the other chamber through adequately sized conduits.

The problem arising from this type of devices is that they not only work under circumstances of seismic activity, but they function as well under normal loads from traffic, wind or temperature, which provokes wear as well as the need of carrying out continuous maintenance operations, for example, the change/reposition of the oil/silicone, the change of worn out parts, etc.

At the same time, mechanical protection devices are known in which the telescopic elements are interrelated by means of parts which block one element in respect to the other and which are designed to break under predetermined shear efforts, substantially higher than the efforts to which the structure may be submitted by normal traffic, wind, etc.

The problem with this type of devices, besides the fact that once the breakage has taken place the device becomes unusable, being necessary to substitute at least the axial blocking means; consists in that the surface of the breakage of this type of materials is frequently not sufficiently clean, so that, once the breakage has taken place, the displacement in one sense is free, in the movement in the contrary direction of return provoked by the seismic vibration, the device may rest blocked, given the irregularities of the breakage surface with the subsequent unsatisfactory working of the same.

Another type of problem of these devices is that the calculation of the cross section of the element which eventually has to break is usually not easy and in any case, the device is designed to meet a determined breaking effort which cannot be adjusted or tested without having to substitute the device for a new one.

### DETAILED DESCRIPTION OF THE INVENTION

The mechanical protection device provided by the invention solves in a fully satisfactory manner the above explained problems thanks to a very effective new structure which does not need any type of maintenance, being easily adjustable to different effort values according to the specific needs in each case.

In this connection, the device of the invention starts from a telescopic structure having two arms, one of them displaceable within the other, both having corresponding attachment means with the peculiarity that the arm with a lower cross section, that is, the arm which is displaceable within the arm with a larger cross section, has multiple grooves in a sense perpendicular to the displacement, which grooves in the normal working situation stand opposite to other grooves of the same size arranged in the arm with larger cross section. Both sets of grooves are blocked by a rigid element, preferably a cylinder which, depending on the axial load to which it is submitted, may displace vertically compressing some elastic means (Belleville washers) which have been previously prestressed. To unblock the device, it is necessary that the axial force exceeds in a certain rate the vertical force with which the cylinders have been prestressed by means of the Belleville washers. Once this value has been exceeded, the cylinders leave the grooves and the element is unblocked. The unblocking force may be adjusted according to the number of washers which have been used and the type and resistance of the same, which washers will be conveniently confined within a protecting enclosure acting on an element applying the force on said cylinder.

The cross section of the arms forming the telescopic element may have whatever polygonal shape, and for a better distribution of the efforts it has been foreseen that the mechanism which has been described may be radially repeated and distributed with the same angles on the different faces defining the regular polygonal section of the device.

At the same time, said mechanism may be repeated longitudinally on all the faces of the device depending on the specific needs of each case.

Starting from this structure, both arms of the device are blocked to each other up to the moment in which an effort is exerted on said arms which is sufficient to exceed the effort of the elastic elements on the various cylinders, provoking the vertical displacement of these latter up to fully release the groove. In this moment, the mechanical protection device is free to permit the displacement between its arms and the dampers which are assembled in parallel to the device start its working, dampening the displacements produced.

In order that the device does not block again in its displacement in the direction opposed to that which has provoked its unblocking two movable parts have been longitudinally arranged within the channel, opposing the tension of some springs which have been arranged flush to the surface on which said cylinder rolls after the device has been unblocked, so that said elements in a normal working situation engage the side faces or bases of the cylinder, preventing this latter to move, while in the situation in that the cylinder leaves the groove it provokes the release of said parts which obstruct said channel, defining a flat rolling surface for the cylinder, which is flush with the rest of the surface on which said cylinder moves.

Therefore, once the device has been unblocked, the same does not block automatically again, being necessary for that to leave free the channel in which said cylinder has to engage, thus being blocked again the device, without the need to change parts or to carry out any additional maintenance work.

### BRIEF DESCRIPTION OF THE DRAWINGS

To complete the following description and with the objective to assist to a better understanding of the characteristics of the invention, according to a preferred embodiment of the same, a set of drawings is enclosed forming part of said description, showing in an illustrative but not limitative form:

FIG. 1, a plant view of a mechanical protection device for civil work structures according to the present invention.

FIG. 2, an elevation view of the assembly of the previous figure.

FIG. 3, a cross section of the previous figures.

FIG. 4, a diametrical cross section of a detail of the blocking devices which form part of the device of the invention.

FIG. 5, an illustration similar to FIG. 4 corresponding to a moment of time after the device has been unblocked.

FIG. 6, an illustration similar to that of FIG. 4 corresponding to a moment of time after that of FIG. 5 in which the device is compressed again and in which the channel is obstructed by the mechanism associated to the same.

FIGS. 7, 8 and 9, illustrate corresponding details in plant view of FIGS. 4, 5 and 6.

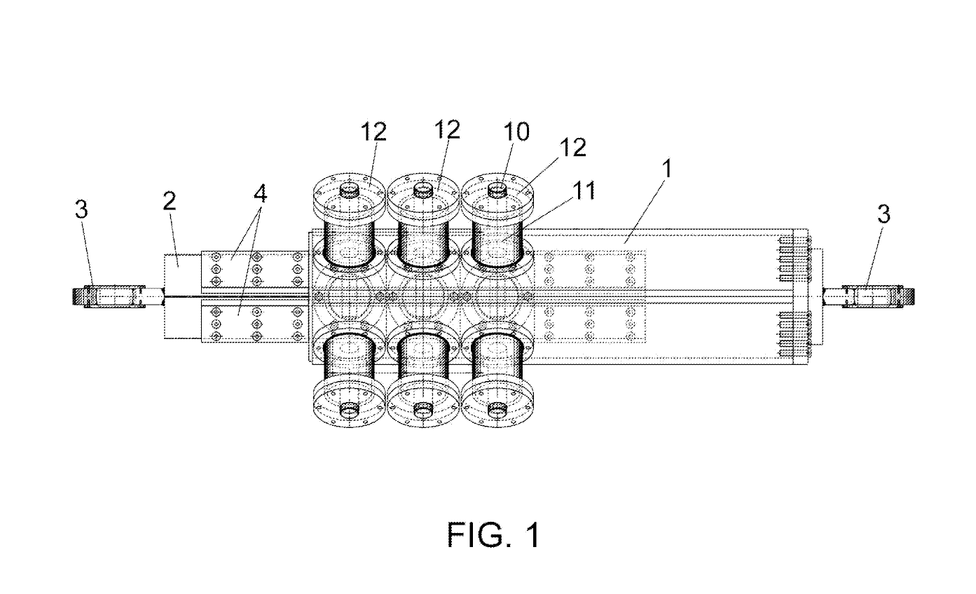

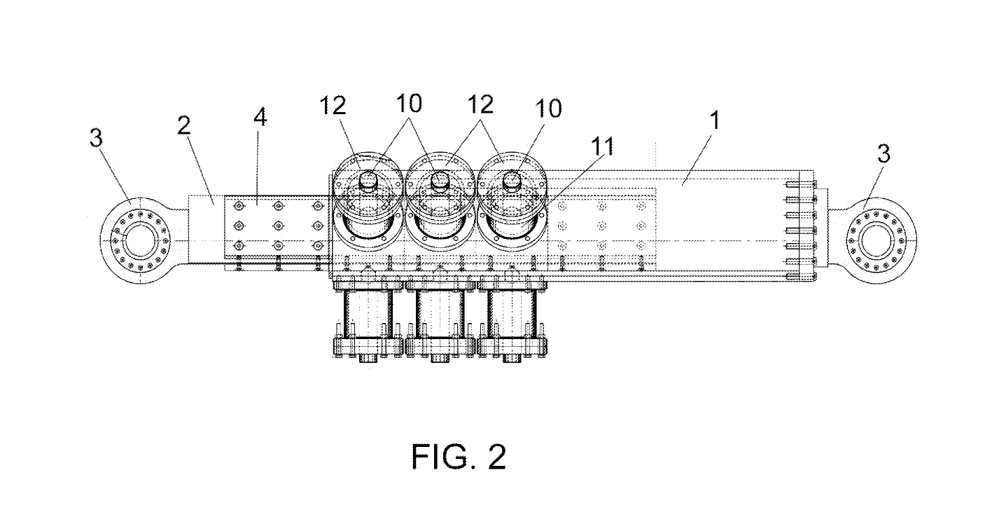

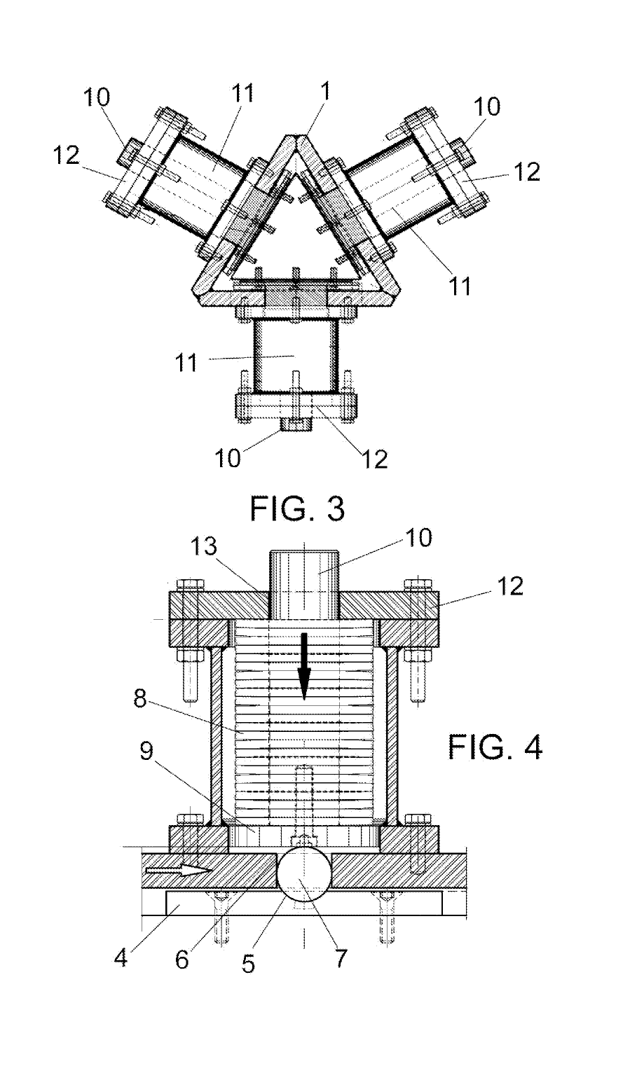

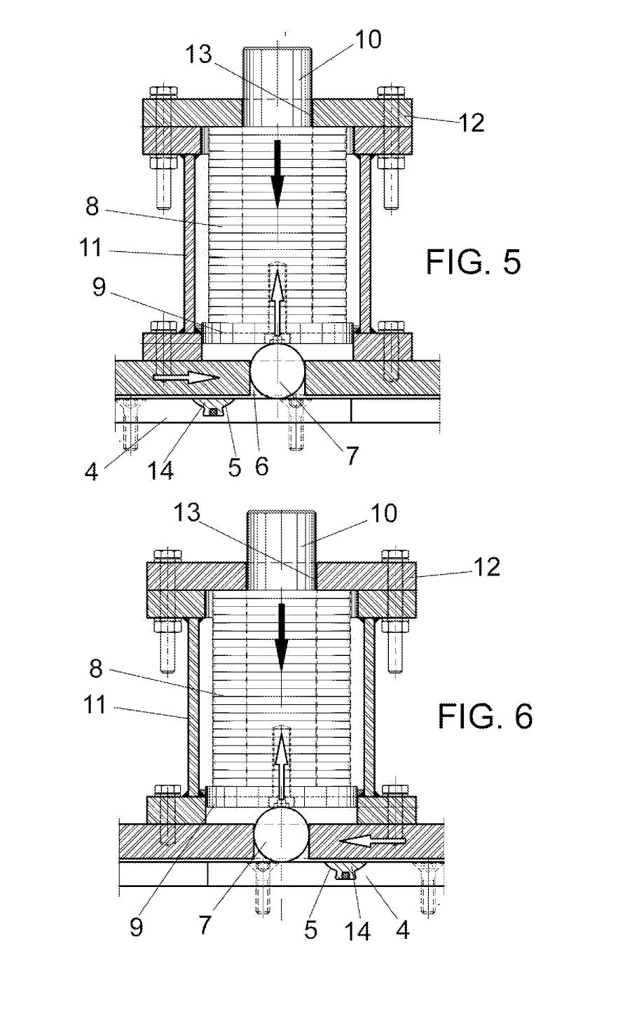

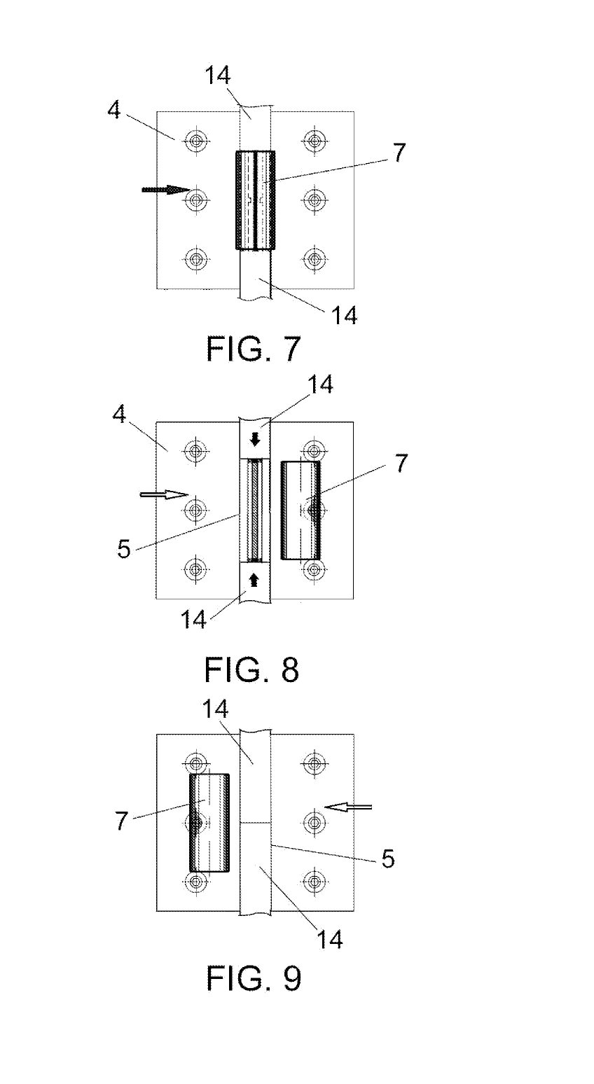

### PREFERRED EMBODIMENT OF THE INVENTION

As is to be seen in the above mentioned figures, the protecting device of the invention is made out of a telescopic structure which in the exemplary preferred embodiment has a triangular cross section with equal sides, but which could obviously adopt other polygonal configurations without affecting the essence of the invention.

Said telescopic structure features a longer arm (1) and a shorter arm (2) with capacity to move within the other arm, having in its corresponding free ends the appropriate anchoring means (3).

On the shorter arm (2) corresponding plates (4) are attached which are flush with the internal faces of the longest arm (1) and having multiple transverse grooves (5) in the same number than the number of blocking mechanisms of the device.

Specifically, each blocking mechanism has an axial chamber (6) within the longer arm in which a blocking element is capable of moving vertically, consisting in this present embodiment in a cylinder (7) which opposes the tension of an elastic element, in this case a set of Belleville washers (8), so that said cylinder is partly encased in the groove (5) of the plate (4) of the shorter arm (2) acting as a blocking element preventing the relative movement of one arm in respect to the other, so that to unblock the device it is necessary to compensate the force exerted by the Belleville washers (8) on the cylinder (7) which force is applied by means of a pusher element (9) having a vertically movable stem (10) on which said washers are located.

The above described assembly is located inside of a housing (11), being the assembly closed by means of a corresponding cover (12) attached by screws to the housing (11) and having a central orifice (13) to permit the passage of the stem (10).

By means of said structure, the arms of the device are blocked one to the other until on said arms a sufficient effort is exerted to compensate the effort of the Belleville washers (8) on the cylinder (7), permitting this latter to move vertically until it fully abandons the groove (5), permitting the displacement of one arm in respect to the other, so that the device is arranged in parallel to various dampers which have the role to dampen the displacements produced after unblocking the device.

In order that the device does not become blocked again in its displacement in the sense opposed to that which provoked its unblocking, it has been foreseen that within the groove (5), two parts (14) are arranged with capacity to move longitudinally within said groove, opposing the effort of some springs which are assembled flush to the surface on which the cylinder (7) rolls once the device is unblocked, so that these elements in the normal working situation engage the side walls or bases of the cylinder, preventing the movement of this latter, however, when the cylinder has abandoned the groove (14) it provokes the release of said parts which obstruct said channel, defining a flat rolling surface for the cylinder, which is flush in respect to the rest of the surface on which said cylinder moves.

Therefore, after unblocking the device, the same does not automatically block again being necessary to let free the groove (5) in which said cylinder (7) must be lodged, thus being the device blocked again without the need to change parts or performing any type of maintenance work.

As is to be observed from the figures, the mechanism which has been described may be repeated the number of times which may be necessary in the longitudinal sense and on the various faces of the device depending on the specific needs in each case with the aim that the various devices be axially and equally distributed.

1. Mechanical device for the seismic protection of civil works, of the type which has a telescopic structure with two arms, one of them movable within the other and having corresponding attachment means, wherein wherein the shorter arm has an axial groove which in the normal working situation is operatively opposite to an axial chamber of the longer arm, so that in said chamber, a blocking element, preferably a cylinder, has the capacity to move vertically in respect to the groove, against the effort of an elastic element, arranged within the corresponding housing.

2. Mechanical device for the seismic protection of civil works, according to claim 1, wherein the telescopic structure has a polygonal cross section with equal sides.

3. Mechanical device for the seismic protection of civil works, according to claim 1, wherein the blocking means between the shorter army and the longer arm are repeated the number of times which may be necessary, both in the longitudinal sense as well as on the different faces of the device.

4. Mechanical device for the seismic protection of civil works, according to claim 1, wherein the grooves of the blocking elements are arranged on corresponding plates attached to the shorter arm, being arranged flush with the internal sides of the longer arm.

5. Mechanical device for the seismic protection of civil works, according to claim 1, wherein the elastic elements acting on the cylinders comprise Belleville washers associated to a pusher element which has a vertically movable stem on which said washers are lodged, the assembly being located within a housing closed by a corresponding cover which has a central orifice for the passage of the stem.

6. Mechanical device for the seismic protection of civil works, according to claim 1, wherein within the groove of an anti blocking means comprises the shorter arm and blocking element which are arranged for the device, once it has been unblocked.

7. Mechanical device for the seismic protection of civil works, according to claim 6, wherein the anti-blocking means is further comprised of two parts longitudinally moveable within the groove, opposing to the effort of some springs and being flush with the surface on which said cylinder rolls after the device is unblocked.
